(19) United States
(12) Patent Application Publication
(10) Pub. No.: US 2008/0051933 A1
(43) Pub. Date: Feb. 28, 2008

(54) VENDING MACHINE HAVING AERIAL DISPLAY SYSTEM

(75) Inventors: Jeffrey L. Vrachan, Agoura Hills, CA (US); Curtis L. Thornton, Simi Valley, CA (US)

Correspondence Address: J C PATENTS, INC., 4 VENTURE, SUITE 250, IRVINE, CA, 92618, US

(73) Assignee: PROVISION INTERACTIVE TECHNOLOGIES, INC, CHATSWORTH, CA (US)

(21) Appl. No.: 11/843,139

(22) Filed: Aug. 22, 2007

Related U.S. Application Data
(60) Provisional application No. 60/839,740, filed on Aug. 23, 2006.

(51) Int. Cl. G06F 19/00

(52) U.S. Cl. 700/231

(57) ABSTRACT

A vending or transaction-based machine having an aerial display system is provided. The aerial display system having a low-cost plastic spherical mirror includes an aerial display system having an inexpensive optical device and a high luminance liquid crystal display (LCD) imaging display to provide expensive envelope images. A display design thereof is designed to attention of potential consumers and sale advertising, promotion coupons or three-dimensional images of products. Once consumers begin to interact with the vending machine, demographic data are collected or correlated with the product purchased or dispensed. The consumer can initiate and conclude a purchase by merely pointing at the desired product. A mechanism is provided that accepts payment by currency, credit card or electronically.

### CROSS-REFERENCE TO RELATED APPLICATION

This application claims the priority benefit of U.S. Application Ser. No. 60/839,740, filed on Aug. 23, 2006. All disclosure of the U.S. application is incorporated herein by reference.

### BACKGROUND OF THE INVENTION

1. Field of the Invention

Embodiments of the present invention relate to vending machines. More particularly, embodiments of the present invention relate to a vending and transaction-based machine having aerial display system used for projecting three-dimensional images of products sold by the vending machine and allowing a consumer to interact with the vending machine.

2. Description of Related Art

Vending machines are ubiquitous and an important source of retail sales for many companies. A wide variety of products are sold by vending machines. For example, cash, cold drinks, coffee, candy, potato chips, phone cards, maps, flowers and many other products. Other products, such as tobacco products, used to be sold through vending machines but are no longer because of concerns that unsupervised minor children could unlawfully purchase the products.

Typically, vending machines include a display portion so that the consumer can view the products available for purchase. The display portion may be window that permits the consumer to see the product hanging on dispensing hooks or a printed display applied to the exterior of the vending machine. Vending machines also include a mechanism for collecting currency, whether cash, credit card or debit card, a plurality of buttons by which the consumer may indicate their desired purchase, a mechanism for disbursing change and a mechanism for disbursing the purchased product.

Vending machines are often placed in locations that are convenient for consumers to access. Thus, they are often found in hotels, apartment complexes, factories, schools, gas stations, mini-marts, convenience stores, grocery stores, recreational areas, airports and other such places.

Vending machines have become so ubiquitous that consumers often by-pass vending machines in favor of making their purchase from a store or other location having a human attendant thereby raising costs. Accordingly, what is needed is a vending machine that attracts consumers and provides promotional content that encourages consumers to make a purchase from a vending machine.

With the increasing prevalence of time-shifting devices, such as digital cable video on demand or TiVO that allow home viewers to skip televised commercials, have put pressure on advertisers to find better ways to target consumers. Thus, what is needed is a vending machine that allows manufacturers of consumer products advertise using in-store promotions. Further, what is needed is a system and method for distributing and tracking the effectiveness of advertisements, coupons and other promotional material distributed from a vending machine. Further still, what is also needed is a vending machine for transactional vending that can dispense digital music, videos, coupons or promotional material.

If a vending or transaction-based machine includes an aerial display system to display three-dimensional images, the machine can be designed to attention of potential consumers and sale advertising, promotion coupons or three-dimensional images of products. Once consumers begin to interact with the vending machine, demographic data are collected or correlated with the product purchased or dispensed. The consumer can initiate and conclude a purchase by merely pointing at the desired product. A mechanism is provided that accepts payment by currency, credit card or electronically.

The aerial display system generates aerial images that appear to float in the air a few inches ahead of the display apparatus. Since the novelty related with floating images, the aerial display system has been adopted for years. The aerial display system normally is disposed inside a wooden structure similar to a size of a refrigerator. In the wooden structure, a display area of static items aligns optically with optical devices generating aerial images of the static items. For example, a shoe item or a food item may be located in a display area to generate an aerial image of the said item. In some applications, the display area includes a visual frequency display apparatus generating aerial visual frequency images, such as a CRT or an LCD. Unfortunately, normal aerial display system requires a large number of shape factors to realize vivid floating or aerial images, which are very heavy and quite expensive. Therefore, the usage of the aerial display system has been limited to commercial applications such as conference or product display in trade exhibitions, or limited to display of jewelry or precious and expensive objects of museum quality.

Another problem of the aerial display system derives from the optical devices used for generating floating images, especially a splitter, glass spherical mirror and a circular polarizer. For example, a spherical mirror is usually a highly polished glass bottom having low distortion. A cost of a display unit having an average size exceeds US$1,000. Furthermore, although the polarizer can prevent a viewer from watching floating images having reflective pollution, it is also a device that costs highly. Due to the high cost of the normal aerial display system, the system has not yet been widely adopted for commercial purposes, and even few consumer applications include an aerial projector display system. In reality, the normal aerial display system is limited to precious objects and trade exhibitions. The high cost of the aerial display system proves reasonable from its ability to attract much attention from consumers.

Apparently, we need a low-cost aerial projecting system which can be adopted for consumer and commercial applications. An effective method to reduce the high cost is to improve on the materials used in the aerial display system, such as glass often used as a material for the spherical mirror. One of the important reasons why the improvement is not realized before is that the plastic technology was not as matured as it has been now. In other words, the tools and the materials were not as effective as they are today. A tolerance between a metal mold and a fabricated part is designated at 0.0001 inch. Conventionally, glass has been the material of choice for a high quality spherical mirror for use in an aerial imaging display device. In the past, only glass spherical mirrors could provide the high quality optical features necessary for presenting a realistic aerial image. High quality glass spherical mirrors are expensive because of the secondary operations needed to prepare the mirror surface after it is heat formed or slumped to shape. These secondary operations include annealing, grinding and polishing. The annealing process is used to strengthen the glass so that it is strong enough to undergo the grinding and polishing operation, as well as adding the additional strength needed to resist breakage during usage. The grinding and polishing stages are necessary because of the limits of the tolerance capabilities of glass forming molds and the physical nature of glass. Unfortunately, the grinding and polishing stages require a considerable amount of manual processing for producing a finished product; therefore, they are often considered semi-automated processes. In addition, glass spherical mirrors also have the serious drawbacks of breakage, heavy weight, difficulty in mounting the mirror and expensive shipping costs. To overcome the limitations and drawbacks of glass, a low-cost version of the glass spherical mirror was developed but it did not provide an acceptable surface finish, was still very heavy and the resulting cost reductions were not comparable to plastic spherical mirror. Clearly, what is needed is a method and system for manufacturing a plastic spherical mirror to reduce the weight of a spherical mirror to approximately one-third that of glass, and for making a low-cost plastic spherical mirror of comparable performance to high quality glass spherical mirror.

### SUMMARY OF THE INVENTION

Embodiments of the present invention provide a vending or transaction-based machine having an aerial display system with a low-cost plastic spherical mirror. The vending or transaction-based machine includes three-dimensional images of a product or products sold by the vending machine.

The present invention provides a method and system for manufacturing a low-cost plastic spherical mirror of comparable performance as that of a high quality glass spherical mirror. In one preferred embodiment of the present invention, a plastic molding is used for manufacturing an optical device for a low-cost plastic spherical mirror. The plastic injection molding method is capable of providing high tolerance, improved process control, and high repeatability. The metal mold for the plastic injection molding provides a tight tolerance for a general envelope dimension of a mirror (not the mirror surface). The spherical radius tolerance can also be held at a tight tolerance. The aforementioned tolerances are comparable to that of the glass spherical mirrors. The metal mold for the plastic injection molding also maintains a high tolerance. In one preferred embodiment of the present invention, a plurality of plastic material formulations has been developed in which a plurality of performance criteria relating to material strength, thermal stability, water absorption, mold shrinkage, material flow into the mold, UL recognition, manufacturing considerations, surface density, lubricant content, and scratch resistance may be satisfied. The selection of the plastic material formulation may be based on the metal mold and part testing results.

In one preferred embodiment of the present invention, vacuum metallization or vacuum deposition may be used for depositing a reflective mirror coating for use as the mirror surface of the spherical mirror. The metal deposited on the plastic surface preferably has a thickness of several microns. The metallization phase is performed after a protective overcoat is spray coated thereon. The vacuum metalized part has improved quality because it is possible to maintain the quality of the coated surface of the plastic material by minimizing the number of surface flaws.

A method for fabricating a plastic spherical mirror according to an embodiment of the present invention includes the following steps:
a) providing a plastic part of a desired size with a mirror surface capable of resisting or preventing distortion or twisting; b) disposing precisely a plurality of plastic injection gates so as to eliminate remnants or knit lines created by plastic resin flow; c) selecting preferred physical dimensions of the plastic part satisfying a plurality of optical performance requirements and physical design requirements; d) forming a plurality of support walls and strategically disposing them in the plastic part; e) selecting a plastic material formulation for certain designs so as to prevent distortions; f) applying A1 optical grade steel having a preferred polished finish to fabricate tools; g) heating and/or cooling metal molds so as to form an optimal curvature on a mirror surface; h) depositing a thin layer of reflective metal coating on the mirror surface of the plastic part; and i) forming a protective overcoat on a metalized mirror surface.

Through executing the aforesaid method of fabricating the plastic spherical mirror, the fabricated plastic spherical mirror includes the following: a plastic part, having a mirror surface supported by a plurality of walls structures on an edge of a mirror frame; preferred physical dimensions of the plastic part; a plastic material formulation; an A1 optical grade finish for the mirror surface of a metal mold formed by polishing; an optimal curvature of the mirror surface formed through heating and cooling the metal mold; a thin layer of reflective metal coating deposited on the mirror surface of the plastic part; and a protective overcoat formed on a metalized mirror surface. In addition, in one preferred embodiment of the present invention, the plastic spherical mirror may further include a plurality of injection gates strategically disposed and preferred physical dimensions of the plastic part. Moreover, a plurality of support walls may be disposed in the plastic part so as to render final design dimensions of the plastic part in one preferred embodiment match final design dimensions of a glass counterpart.

Additionally, embodiments of the present invention also provide an improved vending or transaction-based machine. More specifically, embodiments of the present invention entice consumers to purchase their product from a vending machine and simultaneously provide an advertising platform for additional recurring revenue from the machine, i.e. coupons.

Embodiments of the present invention further provide a reliable contact-less mechanism that the consumer uses to select a product from a vending machine. These embodiments include a detection system that determines the consumer's selection without the use of buttons or other mechanical mechanism to select a product from the vending machine.

Embodiments of the present invention further provide a demographics model that provides an estimate of the biometrics, such as age, of the consumer who uses the vending machine to make a purchase. Demographic data are used to prohibit minor children from accessing product that they are not permitted to purchase from a vending machine.

Embodiments of the present invention also further provide a computer-readable medium comprising instructions for: receiving content for display by aerial imaging system; displaying the content to attract consumers and provide an advertising platform for recurring revenue from the machine from coupons and other promotional items; displaying content in response to a consumer selection; dispensing product or transactional receipts selected by the consumer, and determining demographics summaries relating to the type of product purchased by each consumer class.

When the consumer returns to the advertising platform, they may enter identifying information to receive personalized content. To illustrated, once a consumer establishes a personalized profile and subsequently returns to the advertising platform, the system pushes a customized list of coupons or other promotional items.

A computer-readable medium is also provided by embodiments of the present invention with instructions for: monitoring utilization of a vending machine's products, determining an effective presentation for generating consumer purchases, monitoring the sale of product, and allocating products, receipts or coupons to vending machines that have a history of sales of such allocated products.

Embodiments of the present invention further more specifically provide a vending machine system comprising a plurality of vending machines each having an aerial display system, a detector system that determines the product selected by the consumer; and a demographics system that determines the age, ethnicity and sex of the consumer at the point of sale. The vending machine system includes a communication network that couples each vending machine in the system to at least one server computer. The server computer receives sales data from each vending machine and delivers media content to each vending machine for display to consumers. Media content may include promotional collateral material such as coupons or informational brochures for disbursement to the consumers.

These provisions together with the various ancillary provisions and features which will become apparent to those artisans possessing skill in the art as the following description proceeds are attained by devices, assemblies, systems and methods of embodiments of the present invention, various embodiments thereof being shown with reference to the accompanying drawings, by way of example only and not by way of any limitation.

### BRIEF DESCRIPTION OF THE DRAWINGS

FIG. 1 is a block diagram of an exemplary vending machine in accordance with an embodiment of the present invention.

FIG. 2 is a block diagram of a system of vending machines in accordance with an embodiment of the present invention.

FIG. 3 is a flow diagram of an exemplary method for attracting and completing a sale to a consumer at a vending machine in accordance with an embodiment of the present invention.

FIG. 4 shows an exemplary vending machine in accordance with an embodiment of the present invention.

FIG. 5 is a flow diagram of an exemplary method for fabricating a plastic spherical mirror in accordance with an embodiment of the present invention.

FIG. 6 shows a trimmed plastic part of a plastic spherical mirror in accordance with an embodiment of the present invention.

FIG. 7 is a flow diagram of an exemplary method for fabricating a plastic spherical mirror in accordance with another embodiment of the present invention.

FIG. 8 shows a plastic part injection molded in accordance with another embodiment of the present invention.

### DESCRIPTION OF EMBODIMENTS

In the description herein for embodiments of the present invention, numerous specific details are provided, such as examples of components and/or methods, to provide a thorough understanding of embodiments of the present invention. One skilled in the relevant art will recognize, however, that an embodiment of the invention can be practiced without one or more of the specific details, or with other apparatus, systems, assemblies, methods, components, materials, parts, and/or the like. In other instances, well-known structures, materials, or operations are not specifically shown or described in detail to avoid obscuring aspects of embodiments of the present invention.

For the sake of convenience of understanding, some key terms and phrases are first presented.

A “plastic material formulation” may comprise a homopolymer, a thermoplastic, a copolymer, a polymer blend, a thermoset, a polymer blend, any one of the above material containing performance additives, fillers, or fibers, or any other similar types of polymer material formulations.

The “deposition of a reflective metal coating over the mirror surface of the plastic part” may be accomplished by vacuum deposition, spin coating, spraying, vacuum metallization, sputtering, or any other similar process capable of depositing the reflective metal coating on the order of several microns.

“Low-cost” may be defined as a favorable cost differential as compared to glass of the same dimensional configuration for use as spherical mirrors.

A “glass counterpart” is defined to be a glass spherical mirror of the same dimensional configuration and possesses equivalent functionalities as that of the plastic spherical mirror.

As used herein, the words “may” and “may be” are to be interpreted in an open-ended, non-restrictive manner. At minimum, “may” and “may be” are to be interpreted as definitively including structure or acts recited.

Embodiments of the present invention provide demographic data for determining the acceptance of a product among consumer groups by age, sex and race.

Embodiments of the present invention also further more specifically provide a computer-readable medium comprising instructions for: receiving content for display by aerial imaging system; displaying the content to attract consumer; displaying content in response to a consumer selection; dispensing product selected by the consumer, and determining demographics summaries relating to the type of product purchased by various consumer groups.

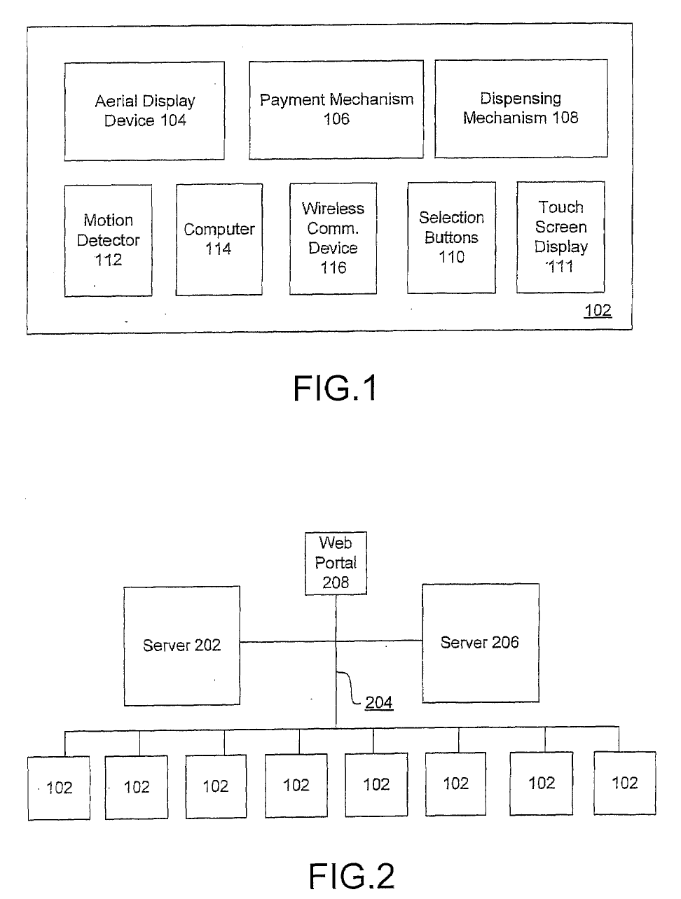

Referring now to the drawings more particularly by reference numbers, a block diagram of an exemplary vending machine 100 in accordance with an embodiment of the present invention is shown in FIG. 1. More specifically, vending machine 100 comprises an enclosure, indicated generally at 102, an aerial display device 104 for generating aerial images of the products sold by the vending machine or used to display advertising of other products/promotions, a payment mechanism 106 for accepting currency and for returning change, as appropriate, and a dispensing mechanism 108 for dispensing products when a consumer makes a purchase. While vending machine 100 may include a plurality of selection buttons 110 for selecting a product from a list of products, such buttons are optional. In other embodiments, a touch screen display 111.

A preferred embodiment of the present invention further provides a reliable contact-less mechanism that the consumer uses to select a product from a vending machine. This embodiment includes the step of generating an aerial image of the available products and a detection system that determines the consumer's selection without the use of buttons or other mechanical mechanism to select a product from the vending machine.

Product selection utilizes aerial imaging device 104 in combination with a gesture recognition system 112. In one preferred embodiment, gesture recognition system 112 includes a one, two, or three-camera or sensor array to detect a gesture by the consumer and computer code executed by computer 114 to interpret natural hand gestures. With gesture recognition system 112, touch-free control of the images displayed by aerial display device 104.′ In the preferred embodiment, gesture recognition system 112 adjusts to the consumer's height and location to optimize detection of hand gestures. Alternatively, gesture recognition system may be an infra-red or sonic monitoring device such as is used in home security systems. Touch-free interaction enables flexible positioning of the display. One preferred gesture recognition system is produced by Advanced Interfaces, Inc. of State College, PA and marketed under the Vision Interface Platform trademark.

Products, not shown, are positioned in the interior of enclosure 102. Products may include cold drinks, coffee, candy, potato chips, phone cards, cash, ring tones for cellular telephones, computer games, movie tickets, songs, videos, maps, flowers, coupons, product literature and many other products. Other products, such as tobacco products may be sold through selected vending machines that include an adult (age estimate) verification algorithm as described more fully below.

Embodiments of the present invention entice consumers to purchase their product from a vending machine. Rather than a static printed exterior, an aerial image is generated and displayed for the consumer. The aerial image is displayed so that it appears to be a three dimensional object to the human eye. This 3D image can changed at video rates to generate the floating image.

Enclosure 102, currency mechanism 106 and dispensing mechanism 108 may be any appropriate device capable of providing the intended function. For example, if cold beverages are to be dispensed by vending machine 100, enclosure 102 may be a box-like insulated enclosure that includes a compressor for maintaining an ambient interior temperature sufficient to maintain the beverage at a selected temperature. If ring tones, songs or other electronic files are to be dispensed, then vending machine 100 includes a mechanism for interfacing with an electronic device such as a MP3 player, PDA or cell phone. In other instances, the dispensing mechanism provides an encoded plastic card that is programmed with electronic data.

Depending on the application currency mechanism 106 may be adapted to accept coins, paper currency, debit cards, credit cards, or all of the listed items. Mechanism 106 may further include a contact-less (wireless) receiver for receiving encoded signals from a device such as a smart card, radio frequency identification (RFID) card or a cellular telephone, using for example, Blue Tooth technology, for automatically deducting the purchase amount from an established account.

The aerial display system 104 is coupled to a communication network by a computer system 114 and a communication device 116. The communication device may be one of three preferred types of communication types: hard wired by a dial up (POTS) telephone line, wireless cell phone or satellite, or a Wi-Fi network. Preferably, device 116 utilizes the cellular telephone network to transfer information to a central location. Information transfer may occur on an automatic basis or in response to an externally supplied prompt. Thus, the daily sales records are transferred to the central location and recorded.

FIG. 2 illustrates a plurality of geographically distributed vending machines 100 coupled to a server system 202 by a communication network 204. In this manner, content can be downloaded from a remote server system 202 to each vending machine 100. Each vending machine includes aerial display device 104, as noted above, which in turn include computer system 114. Computer system 114 stores downloaded content in computer readable medium for display by aerial display device 104. Content may include an attraction segment to draw the attention of potential consumers and a sales segment that is directed to the sale of a specific product based on 1) customer demographics, 2) available products or 3) a consumer selection. Alternatively, the content may be other general advertising that may not be related to the products in the vending machine.

Computer system 114 also executes a computer program stored in computer readable medium that monitors for the presence of consumers who may be either watching the displayed content or who may desire to purchase a product.

When the consumer subsequently returns to the advertising platform, they may enter identifying information to receive personalized content. The identifying information may be a PIN or other personalized identification number or a biometric comparison such as fingerprint or facial feature. To illustrate, once a consumer establishes a personalized profile and subsequently returns to the advertising platform, the system pushes a customized list of coupons or other promotional items tailored to the individual needs or stated requirements of the consumer.

Each system 104 includes a high bright display that is capable of projecting an image through the optical path of aerial display system 104 and into the air for viewing by the consumer. This displayed image is projected away from the vending machine to cause potential consumers to stand in a specific area in order to best view the image. Thus, detector 112 may be focused on a defined area (where the consumer is motivated to interact with the image) to detect consumer motion. In this manner, consumers may reach for a displayed product thereby indicating their desire to purchase the product rather than manually pressing a product selection button on the exterior of the vending machine.

In other embodiments, the consumer is provided the opportunity to manipulate the image of the product before purchase. Thus, the consumer can rotate the image of the product, open the package to view the contents and, when satisfied, conclude the purchase by selecting a displayed aerial button or a mechanical button if provided on the enclosure of the vending machine.

The server system may comprise any suitable computer server executing any commercially available operating system and application program. In an embodiment of the invention, such as illustrated in FIG. 2., the server system may include a plurality of server machines, such as 202 and 206, which may be geographically dispersed in separate data centers, and a plurality of vending machines in addition to the number illustrated. Thus for an embodiment of the invention, the server system, in combination with any suitable communication network, load balancer and control programs, communicate with a plurality of vending machines each of which receives content and communicates transactions requests to the server system.

One or both of the servers 202 and 206 may support a web portal 208 through which statistical information may be monitored by a brand manager to verify the effectiveness of a promotional campaign. The web portal may also be used to encourage consumers to register for specific coupons to be delivered from the portal or at the vending machine 100.

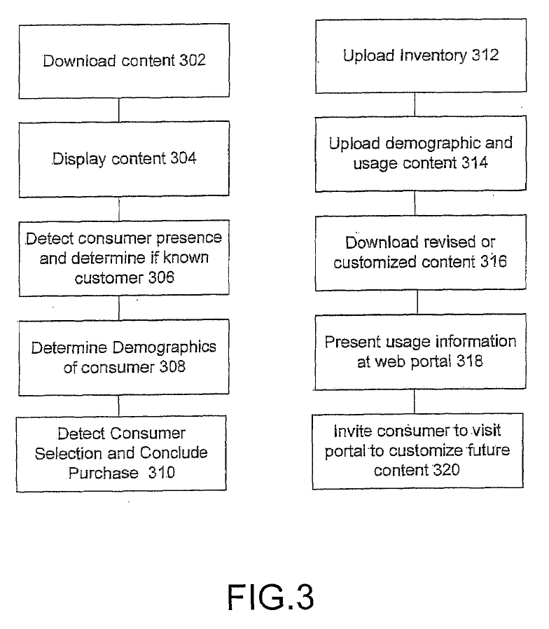

FIG. 3 illustrates a method for improving vending machine operations. An embodiment of the present invention provides a display system that entices the consumer to stop, evaluate the product or products being sold and to purchases products.

Embodiments of the present invention further more specifically provide a vending machine system comprising a plurality of vending machines each having an aerial display system, a detector system that determines the product selected by the consumer; and a demographics system that determines the age, ethnicity and sex of the consumer at the point of sale. The vending machine system includes a communication network that couples each vending machine in the system to at least one server computer. The server computer receives sales data from each vending machine and delivers media content to each vending machine for display to consumers. Media content may include promotional collateral material such as coupons or informational brochures for disbursement to the consumers.

As is well understood, vending machine products are enclosed in the enclosure and a display device projects an aerial image of the products available for sale through the vending machine. Thus, once the vending machine is set up and stocked, content is downloaded as indicated at 302. The content may include various segments of video or graphics that are displayed for potential consumers passing by the vending machine. As indicated at step 304, the content is displayed to the consumer. The content may include an introductory segment that is always changing. The content may also include pricing information or product information or it may simply be an attention-getting video clip.

When a consumer or consumers stop to watch the content, the motion detector 112 provides the information on the number of the consumers to computer 114. The motion detector 112 also detects whether the consumer desires to purchase one of the products or is a returning customer who had indicated the need for customized content as indicated at step 306.

While the consumer is present in front of the vending machine, cameras are focused on the face and upper torso area of the consumer to determine demographic data associated with the consumers who either watch the video content and/or purchase a product from the vending machine as indicated at step 308.

Demographic data is automatically recognizes and classifies onlookers into different demographic segments including gender, race, and age-range. Using this data, management at the central location can continuously measure retail operation in terms of the number, duration and demographic composition of the audience. Further, using this information, the media content displayed by each vending machine can be changed, in real time, based on the demographics of the audience. Further still, using this data, adult products (such as tobacco or alcohol products) are not distributed to minors. A preferred demographic recognition algorithm is commercially available from Advanced Interfaces, Inc. and marketed under the Customer Intelligence trademark.

When the consumer deposits currency and the motion detector detects the consumer's choice, a purchase is concluded by dispensing the selected product as indicated at step 310. Selection in preferably occurs when the consumer points to a location in space in response to an aerial prompt. The consumer motion within the volumetric location during a defined time window indicates the consumer's choice.

At intermittent times or defined, each vending machine 100 will establish contact with server system 202 over the communication network 204. Then, computer 114 will upload an inventory report as indicated at step 312 and demographic and usage data as indicated at step 314. The server system 202 then determines if it is advisable to download revised or new content as indicated at 316.

The uploaded information is then made available on a web portal as indicated at 318 so that a brand manager can monitor coupon or product distribution and usage in real time. The web portal is also used by the consumer to customize the type of content to be displayed by either the aerial imaging device, a flat panel display or both. Further, if the consumer desires, they can indicate their preference as to the type of product for which they are interested in receiving product information, coupons or related promotional items as indicated at 320.

With the present invention, brand managers are provided with real-time vending machine and web portal statistics. It is thus possible to garner real-time return on investment statistical information from each in-store location and web portal activity. The consumer preferences are protected by a password before they are able to receive personalized coupons. The brand manager receives real time redemption statistics categorized by the day, week, month or time of day. The brand manager may also run statistics based on the promotion type, such as category of user interest, most impactful or creative ad or coupon, typical user demographic data, psychographics, promotion click-throughs or seasonality data.

At the point of sale, the aerial imaging device attracts attention while promotional features on either an optional screen or on the touch screen provides real-time incentives at point-of-purchase to increase sales. The consumer may redeem promotions coupons to obtain “access codes” for use on websites for other promotions or receive customized advertising/coupons based on their stated preferences.

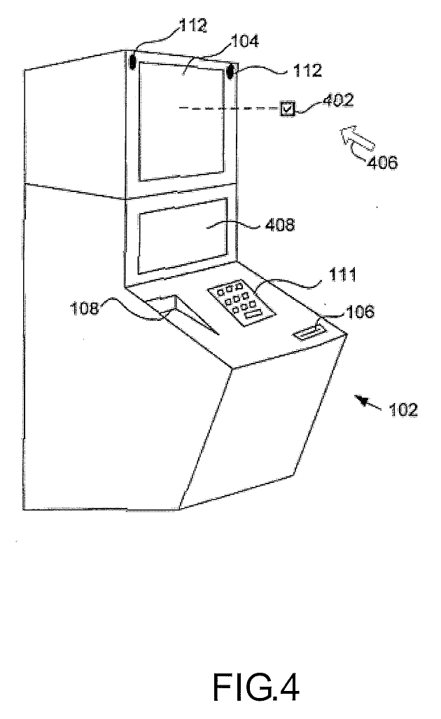

Embodiments of the present invention are shown in FIG. 4 having an aerial display system that generates an aerial image 402, a detector system 112 that determines the product selected by the consumer 404 by detecting a hand-gesture as indicated at 406; and a demographics system that determines the age, ethnicity and sex of the consumer at the point of sale. Products are dispensed through dispensing mechanism 108 and paid for by use of payment mechanism 106 or touch screen 111. Products may include promotional collateral material such as coupons or informational brochures for disbursement to the consumers as well as other products, such as food, drinks or any other product that may be sold or distributed by—a vending machine. Sales are tracked by a computer internal to the vending machine.

Since the problem of the previous aerial display system results from expensive optical devices used for generating floating images, especially a splitter, a glass spherical mirror and a circular polarizer. Therefore, embodiments of the present invention provide an aerial display system having a low-cost plastic spherical mirror, used for manufacturing a plastic spherical mirror to reduce the weight of a spherical mirror to approximately one-third that of glass, and for making a low-cost plastic spherical mirror of comparable performance to high quality glass spherical mirror.

A spherical mirror is well-known in the art and usually includes a glass bottom having an indented surface. The indented surface is coated with evaporated aluminum as a reflective surface. The glass bottom is usually preferred for use in an aerial display system in current technology because it is believed that a sphericity tolerance from one edge to another edge must be maintained as at least ±0.05% so as to minimize distortion and ensure realistic representation of an object. Unfortunately, such spherical mirror is heavier and more expensive and has only limited commercial applications.

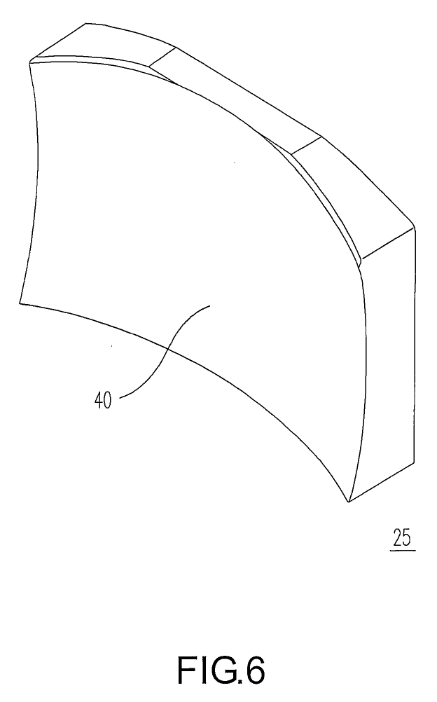

Hence, a mirror surface of the present invention, a mirror surface is not only lighter but also inexpensive. A plastic spherical mirror having a lighter weight is applied in the present invention to simplify the coupling of the mirror surface to the enclosure 102. In one embodiment of the present invention, referring to FIG. 6, a plastic injection mold is used to fabricate a plastic part 25 having a low-cost plastic spherical mirror. In an embodiment of the present invention, a plastic injection molding process is used for fabricating the plastic part 20 of a plastic spherical mirror. In the present embodiment of the present invention, the plastic injection molding process is capable of providing a dimensional tolerance of ±0.0001 inch for a parabolic plastic mirror that ranges from a diameter of from about 5 inches to about 36 inches, in certain preferred embodiments of the present invention. Although the tooling for the plastic injection molding process is relatively expensive, the cost per each plastic part 20 manufactured is however very low. A plurality of complex geometries is reproducible using the plastic injection molding process according to an embodiment of the present invention and may be limited only by the manufacturability of a metal mold.

Plastic technologies, the available tools and materials have advanced such that by selective combination, high quality, low cost plastic spherical mirrors in accordance with the present invention are now possible. By selecting metal mold tolerances, it is possible that the resulting plastic parts can be specified and held in the tens of thousandths of an inch or better by carefully selecting the appropriate materials that are able to emulate the thermal stability and durability of glass. Preferably, the materials endure the type of operating conditions that in the past that only glass spherical mirrors could have tolerated.

In an embodiment of the present invention, a metal mold's final finish may be implemented by means of machining and polishing or other similar finishing methods capable of producing an adequate finish quality, such as an A1 grade or a grade that is considered as the finest finish available for a plastic part 20.

In the present embodiment of the present invention, the plastic injection molding process is capable of providing a dimensional tolerance of ±0.0001 inch for a parabolic plastic mirror that ranges from a diameter of from about 5 inches to about 36 inches. Procedures utilized in the injection molding process are well-known to people skilled in the art, and thus are not to be described in detail herein.

In the present embodiment, a metal mold for plastic injection molding process must be machined to provide plus or minus 0.030 inch tolerance, or better, for a general envelope dimension and a spherical radius tolerance of plus or minus 0.05% for the plastic part (not the mirror surface 40). The aforementioned tolerances are comparable to the glass spherical mirrors. The metal mold is capable of holding a tolerance of about ±0.0001 inch.

In an embodiment of the present invention, a plurality of plastic material formulations 50 may be used for fabricating the plastic spherical mirror in which a plurality of performance criteria are satisfied, such as material strength, thermal stability, water absorption, mold shrinkage, material flow into the mold, UL recognition, manufacturing considerations, surface density, lubricant content, and scratch resistance. In one embodiment, the plastic material, once the molding operation is complete, has 80/50 scratch dig or better.

In an embodiment of the present invention, the plastic material formulations 50 may comprise one of the following: optical-grade polycarbonate, natural-grade polycarbonate, UV-grade polycarbonate, polyetherimide, glass-filled grade polyetherimide, PMMA (acrylic), and other comparable plastic materials having similar performance criteria. The selection of the plastic material formulation 50 may be based on the degree of precision for the mold tooling as well as experimental results from part testing. In one embodiment, the plastic material has optical clarity and is substantially transparent.

In an embodiment of the present invention, a metal layer may be coated over the mirror surface 40 of the trimmed plastic part 25 by performing a vacuum metallization or a vacuum deposition process (in FIG. 6) or the plastic spherical mirror treated with an evaporated metal vapor. The thickness of the metal deposited on the plastic surface is preferably about four to eight microns. The metalizing phase is followed by a spray coating of a protective overcoat on a metalized mirror surface. The protective coating may be a resist material or a plasticized liquid that hardens to a solid film layer upon exposure to room temperature.

The plastic part that has been vacuum metalized may possess improved quality because of improved quality control of the surface of the plastic material that is being coated by means of the minimizing of the amount of flaws that are on the plastic surface resulting from the molding process. Furthermore, the metallization has excellent adhesion with respect to the mirror surface 40 of the underlying plastic part 25.

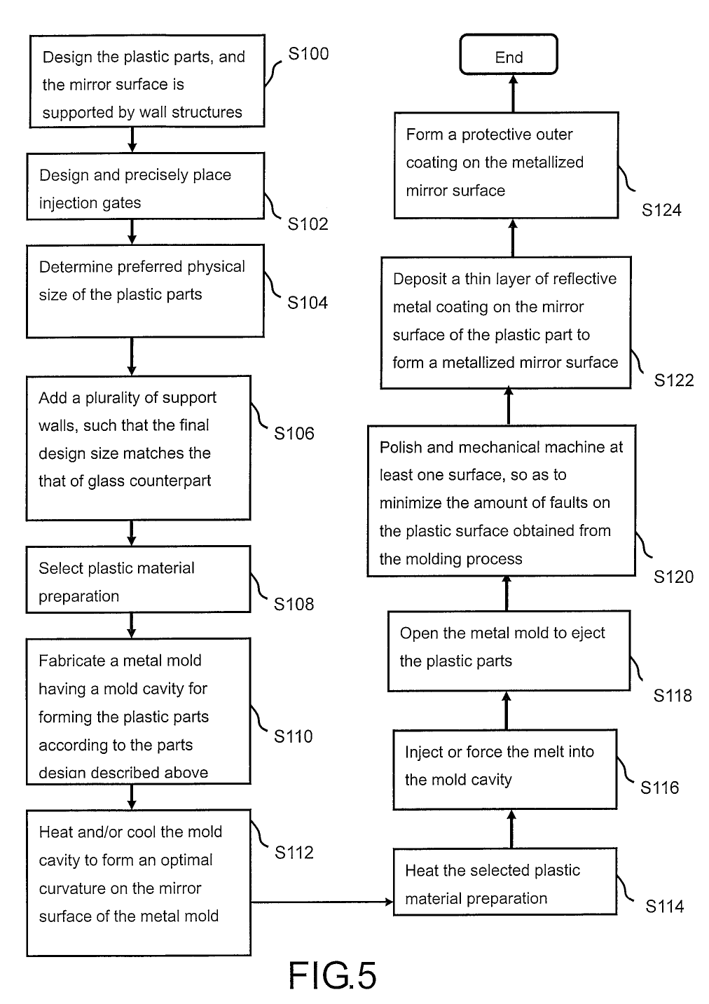

Referring to FIG. 5, a method for fabricating the plastic spherical mirror, in which the plastic part 25 of relatively thin thickness holds its form/shape after being heated and cooled, may include a plurality of the following:

### Part Design

a) designing the plastic part such that the mirror surface is supported by a plurality of wall structures for preventing distortion or twisting thereof (S100); wherein the actual number of wall structures will vary depending on the size of the mirror and may range from one for small mirrors to three or more for the larger mirrors. One skilled in the art will appreciate that the number of such wall structures are engineering considerations and will vary depending on the specific application;

b) designing for precisely and evenly placing a plurality of injection gates with the intent of ensuring the elimination of remnants or knit lines created by plastic resin flow (S102); wherein the actual number of the injection gates will vary depending on the size of the mirror and may range from one for small mirrors to one or more for the larger mirrors. One skilled in the art will appreciate that the number of such injection gates are engineering considerations and will vary depending on the specific application. In one embodiment, at least one injection gate is aligned with each of the wall structures;

c) determining a preferred physical size of the plastic part 20 for satisfying a plurality of optical performance requirements and physical design requirements (S104), including 80/50 scratch dig requirements and able to maintain the physical dimensions over time;

d) including a plurality of support walls in the mold formed plastic part 20 so that the final design dimensions of the plastic part 20 has rigidity that matches that of a glass mirror (S1 06);

### Material Selection

a) selecting a plastic material formulation based upon an ability to resist deformation according to a plastic part quality specification (S108); wherein the plastic material may be an optical grade of plastic such as is commonly used for cosmetic mirrors or other transparent plastic material.

### Mold Tooling Processing

a) fabricating a metal mold including a mold cavity for forming the plastic part according to the part design described above, wherein a mirror surface of the metal mold is polished to an excellent optical grade finish (S110) and preferably, the metal mold is manufactured from class A tool steel;

b) heating and/or cooling the mold cavity to form an optimal curvature on the mirror surface of the metal mold (S112);

### Plastic Injection Molding

a) heating the selected plastic material formulation until a melt thereof is obtained (S114);

b) injecting or forcing the melt into the mold cavity where it is cooled to obtain the plastic part 25 of desired size and shape (S116), it being understood that the injection process requires monitoring the temperature and flow rate of the melted plastic to maximize flow rate but at the same time minimize turbulence;

c) opening the metal mold to eject out the plastic part (S118); and

d) polishing or machining at least one surface to minimize surface defects (S120).

### Mirror Formation

a) depositing a thin layer of a reflective metal coating on the mirror surface of the plastic part to form a metalized mirror surface (S122); and

b) forming a protective overcoat on the metalized mirror surface (S124). The protective overcoat is a resist or plastic material that solidifies at room temperature to provide a protective barrier over the mirror prior to assembly. This protective overcoat is intended to be removed once the plastic mirror is mounted in an aerial display unit.

Referring to FIG. 6, an embodiment of a trimmed plastic part 25 for use for a plastic spherical mirror 10 in accordance with the present invention is illustrated.

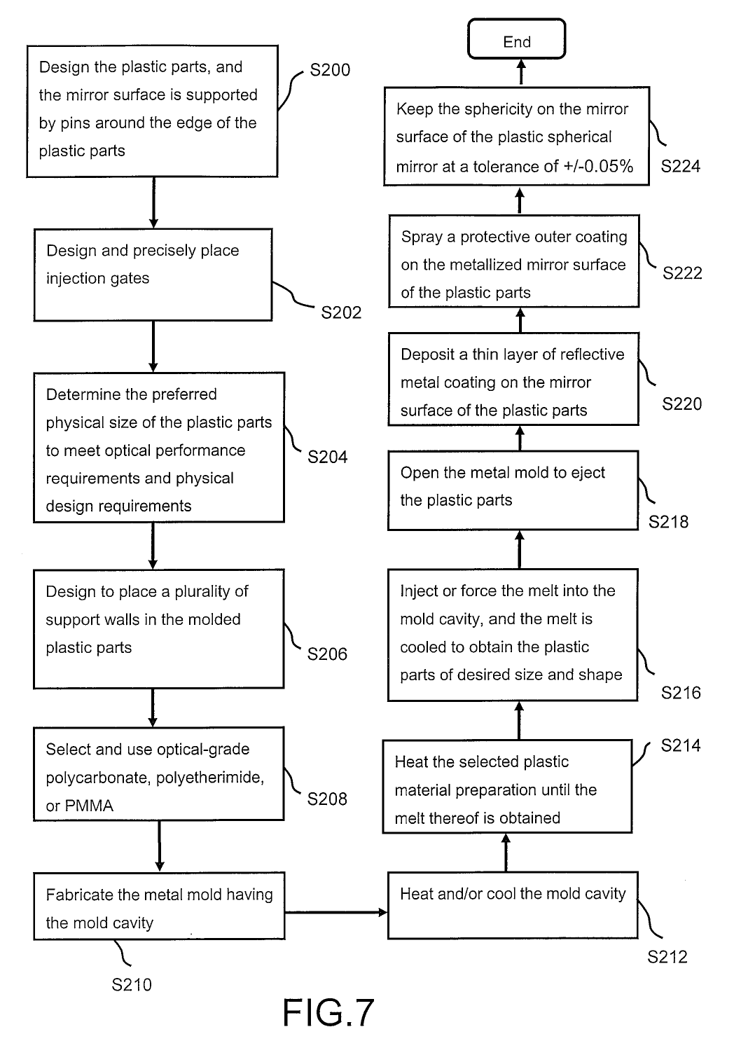

Referring to FIG. 7, a method for fabricating the plastic spherical mirror according to another embodiment of the present invention, in which the plastic part has a thickness sufficient to hold its form/shape after being heated and cooled. In one embodiment, the concave region of the mirror has a thickness of 1.0 cm or less while the periphery may have a thicker thickness. In general, the fabrication of the plastic part may include a plurality of the following steps:

### Part Design

a) designing the plastic part 20 such that the frame of the plastic part is supported by a plurality of ejector pins thereon for preventing distortion or twisting thereof, wherein, for example, 28 ejector pins are disposed around the edge of the plastic part for facilitating part removal from the metal mold without distorting the surface geometry or damaging the mirror surface 40 finish (S200);

b) designing for precisely and evenly placing a plurality of plastic injection gates with the intent of ensuring the elimination of remnants or knit lines created by plastic resin flow (S202);

c) determining a preferred physical size of the plastic part for satisfying a plurality of optical performance requirements and physical design requirements (S204);

d) designing for strategically placing a plurality of support walls in the mold formed plastic part (S206);

### Material Selection

a) selecting an optical-grade polycarbonate, polyetherimide, or PMMA (acrylic) as the plastic material formulation for use as the plastic spherical mirror (S208).

### Mold Tooling Processing

a) fabricating a metal mold including a mold cavity for forming the plastic part according to the part design described above, wherein the mirror surface of the metal mold is fabricated using a high grade steel to an A1 finish (S210); and

b) heating and/or cooling the mold cavity to form an optimal curvature on the mirror surface of the metal mold (S212).

### Plastic Injection Molding

a) heating the selected plastic material formulation until a melt thereof is obtained (S214);

b) injecting or forcing the melt into the mold cavity where it is cooled to obtain the plastic part 20 of desired size and shape (S216); and

c) opening the metal mold to eject out the plastic part 20 (S218).

### Mirror Formation

a) depositing a thin layer of a reflective metal coating on the mirror surface of the plastic part using vacuum metallization or vacuum deposition with a thickness of, preferably, four to eight microns to obtain a metalized mirror surface (S220);

b) spray coating a protective overcoat on the metalized mirror surface of the plastic part 20 (S222); and

### Finished Part Inspection

a) maintaining sphericity on the mirror surface of the plastic spherical mirror at a tolerance of ±0.05% (S224).

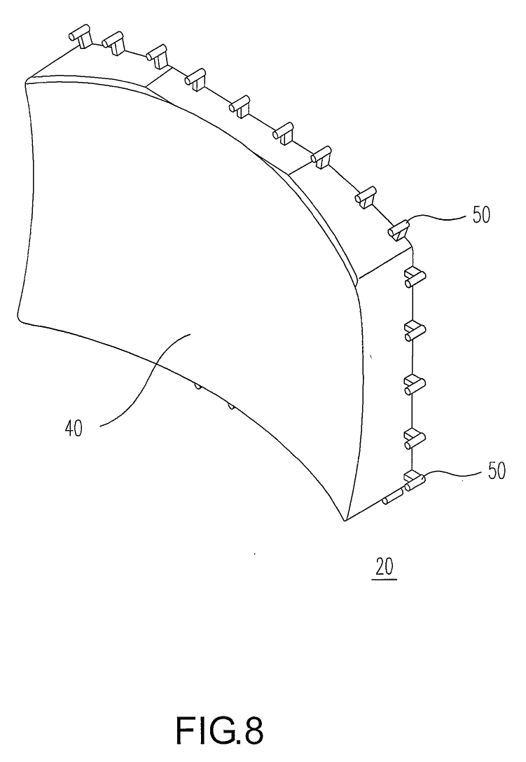

Referring to FIG. 8, a plastic part 20 formed by a plastic injection molding process in accordance with another embodiment of the present invention is illustrated, wherein a plurality of ejector pins 50 are disposed around the edge of the plastic part 20 to facilitate part removal from the metal mold without distorting the surface geometry or damaging the mirror surface 40. The actual number of ejector pins will vary depending on the size of the mirror and may range from three for small mirrors to four or more for the larger mirrors. One skilled in the art will appreciate that the number of such ejector pins are engineering considerations and will vary depending on the specific application.

In one embodiment, the plastic part 20 includes a frame or flange region that has a slightly thicker thickness than the central portion of the plastic part. The flange is placed in contact with the ejector pins and is the only region where such ejector pins contact plastic part.

In another embodiment, a mold release agent is sprayed in to the mold prior to the molding process to facilitate removal of the plastic part from the mold.

A “server or “server machine” for purposes of embodiments of the present invention may be any device having a processor. By way of example only, a “server machine” may be a mainframe computer, a personal computer executing server software, a server, or any of the like. By further way of example only, a “server machine” is merely representative of any type of computer-based product, and so forth. Further, a “server machine” may be any suitable server (e.g., database server, disk server, file server, network server, terminal server, etc.), including a device or computer system that is dedicated to providing specific facilities to other devices attached to the communication network. A “server machine” may also be any processor-containing device or apparatus, such as a device or apparatus containing CPUs or processors. A “server machine” further includes a software program running on a hardware device, representing a virtual computing machine.

A “processor” includes a system or mechanism that interprets and executes instructions (e.g., operating system code) and manages system resources. More particularly, a “processor” may accept a program as input, prepares it for execution, and executes the process so defined with data to produce results. A processor may include an interpreter, a compiler and run-time system, or other mechanism, together with an associated host computing machine and operating system, or other mechanism for achieving the same effect. A “processor” may also include a central processing unit (CPU) that is a unit of a computing system that fetches, decodes and executes programmed instruction and maintains the status of results as the program is executed. A CPU is the unit of a computing system that includes the circuits controlling the interpretation of instruction and their execution.

A “computer program” or “operating system” may be any suitable program or sequence of coded instructions that are to be inserted into a computer, well known to those skilled in the art. Stated more specifically, a computer program is an organized list of instructions that, when executed, causes the computer to behave in a predetermined manner. A computer program contains a list of ingredients (called variables) and a list of directions (called statements) that tell the computer what to do with the variables. The variables may represent numeric data, text, or graphical images.

A “computer-readable medium” for purposes of embodiments of the present invention may be any medium that can contain, store, communicate, propagate, or transport a program (e.g., a computer program) for use by or in connection with the instruction execution system, apparatus, system or device. The computer-readable medium can be, by way of example only but not by limitation, an electronic, magnetic, optical, electromagnetic, infrared, or semiconductor system, apparatus, system, device, propagation medium, or computer memory.

Reference throughout the specification to “one embodiment,” “an embodiment,” or “a specific embodiment” means that a particular feature, structure, or characteristic described in connection with the embodiment is is included in at least one embodiment of the present invention and not necessarily in all embodiments. Thus, respective appearances of the phrases “in one embodiment,” “in an embodiment,” or “in a specific embodiment” in various places throughout this specification are not necessarily referring to the same embodiment. Furthermore, the particular features, structures, or characteristics of any specific embodiment of the present invention may be combined in any suitable manner with one or more other embodiments. It is to be understood that other variations and modifications of the embodiments of the present invention described and illustrated herein are possible in light of the teachings herein and are to be considered as part of the spirit and scope of the present invention.

Further, at least some of the components of an embodiment of the invention may be implemented by using a programmed general-purpose digital computer, by using application specific integrated circuits, programmable logic devices, or field programmable gate arrays, or by using a network of interconnected components and circuits. Connections may be wired, wireless, by modem, and the like.

It will also be appreciated that one or more of the elements depicted in the drawings/figures can also be implemented in a more separated or integrated manner, or even removed or rendered as inoperable in certain cases, as is useful in accordance with a particular application. It is also within the spirit and scope of the present invention to implement a program or code that can be stored in a machine-readable medium to permit a computer to perform any of the methods described above.

Additionally, any signal arrows in the drawings/Figures should be considered only as exemplary, and not limiting, unless otherwise specifically noted. Furthermore, the term “or” as used herein is generally intended to mean “and/oru unless otherwise indicated. Combinations of components or steps will also be considered as being noted, where terminology is foreseen as rendering the ability to separate or combine is unclear.

As used in the description herein and throughout the claims that follow, “a,” “an,” and “the” includes plural references unless the context clearly dictates otherwise. Also, as used in the description herein and throughout the claims that follow, the meaning of “in” includes “in” and “on” unless the context clearly dictates otherwise.

The foregoing description of illustrated embodiments of the present invention, including what is described in the Abstract, is not intended to be exhaustive or to limit the invention to the precise forms disclosed herein. While specific embodiments of, and examples for, the invention are described herein for illustrative purposes only, various equivalent modifications are possible within the spirit and scope of the present invention, as those skilled in the relevant art will recognize and appreciate. As indicated, these modifications may be made to the present invention in light of the foregoing description of illustrated embodiments of the present invention and are to be included within the spirit and scope of the present invention.

Thus, while the present invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the present invention. It is intended that the invention not be limited to the particular terms used in following claims and/or to the particular embodiment disclosed as the best mode contemplated for carrying out this invention, but that the invention will include any and all embodiments and equivalents falling within the scope of the appended claims.

What is claimed is:

1. A vending machine having a spherical display system, comprising:
an aerial display system, having a plastic spherical mirror used for projecting a three-dimensional image of a product;
a dispensing mechanism for dispensing the product in response to a purchase decision by a consumer;
a motion detector for determining the product selected by the consumer;
means for determining demographic data of the consumer;
a computer for controlling operation of the vending machine; and
a connection to a communication network.

2. The vending machine of claim 1, wherein the plastic spherical mirror of the aerial display system comprises:
a plastic part comprised of a plastic material formulation, comprising a mirror surface of the plastic part supported by a plurality of wall structures on an edge of the mirror surface, wherein the mirror surface comprises a sphericity, a physical dimension, an A1 optical grade finish, a curvature;
a thin layer of metal coating, deposited on the mirror surface of the plastic part; and
a protective overcoat, formed on the mirror surface.

3. The vending machine of claim 2, wherein the plastic spherical mirror comprises a plurality of injection gates disposed at a plurality of positions, and wherein the plastic part comprises a physical size.

4. The vending machine of claim 2, wherein the plastic spherical mirror comprises a plurality of support walls disposed on the plastic part so that final design dimensions thereof matches those of a glass counterpart.

5. The vending machine of claim 2, wherein the plastic material formulation is selected based upon satisfying of a plurality of performance criteria relating to material strength, thermal stability, water absorption, mold shrinkage, material flow into the mold, UL recognition, manufacturing considerations, surface density, lubricant content, and scratch resistance.

6. The vending machine of claim 2, wherein the plastic material formulation is selected from the group consisting of an optical-grade polycarbonate, a natural-grade polycarbonate, a UV-grade polycarbonate, a polyetherimide, a glass-filled grade polyetherimide, and a PMMA (acrylic).

7. The vending machine of claim 1, further comprising a server machine coupled to the vending machine by the communication network.

8. The vending machine of claim 1, further comprising a plurality of vending machines coupled to the server machine by the communication means.

9. The vending machine of claim 2, further comprising a contact-less means for selecting a product.

10. A vending machine system comprising a plurality of vending machines each including a plurality of products, a currency collection mechanism and a product dispensing mechanism, the vending machine comprising:
a detection system determining a consumer's selection;
an aerial display system having a plastic spherical mirror used for displaying changing, three-dimensional aerial image of products being sold; and
a computer-readable medium comprising instructions for: receiving content for display by aerial imaging system; displaying the content to attract consumers; displaying content in response to a consumer selection; and dispensing a product selected by the consumer.

11. The vending machine system of claim 10, wherein the plastic spherical mirror of the aerial display system comprises:
a plastic part comprised of a plastic material formulation, comprising a mirror surface of the plastic part supported by a plurality of wall structures on an edge of the mirror, wherein the mirror surface comprises a sphericity, a physical size, an A1 optical grade finish, a curvature;
a thin layer of reflective metal coating, deposited on the mirror surface of the plastic part; and
a protective overcoat formed on the mirror surface.

12. The vending machine system of claim 11, wherein the plastic spherical mirror comprises a plurality of injection gates disposed at a plurality of positions, and wherein the plastic part comprises a physical dimension.

13. The vending machine system of claim 11, wherein the plastic spherical mirror comprises a plurality of support walls disposed in the plastic part so that final design dimensions of the plastic part match those of a glass counterpart.

14. The vending machine system of claim 11, wherein the plastic material formulation is selected based upon satisfying of a plurality of performance criteria relating to material strength, thermal stability, water absorption, mold shrinkage, material flow into the mold, UL recognition, manufacturing considerations, surface density, lubricant content, and scratch resistance.

15. The vending machine system of claim 11, wherein the plastic material formulation is selected from the group consisting of an optical-grade polycarbonate, a natural-grade polycarbonate, a UV-grade polycarbonate, a polyetherimide, a glass-filled grade polyetherimide, and a PMMA (acrylic).
